(19) United States
(12) Patent Application Publication
(10) Pub. No.: US 2007/0204474 A1
(43) Pub. Date: Sep. 6, 2007

(54) Laser level

(76) Inventor: Yu-Sung Lin, Taipei (TW)

Correspondence Address: Raymond Sun, 12420 Woodhall Way, Tustin, CA, 92782, US

(21) Appl. No.: 11/449,003

(22) Filed: Jun. 7, 2006

(30) Foreign Application Priority Data
Mar. 3, 2006 (TW) 95107193

(51) Int. Cl. G01C 15/00

(52) U.S. Cl. 33/286

(57) ABSTRACT

A laser level generates an emitted laser beam and a cross laser beam plane. The laser level includes a frame, a pendulum pivotally mounted to the frame to rotate about two axes with respect to the frame in a manner such that the gravity center of the pendulum defines a plumb line along the gravity direction, a laser module provided in the pendulum to generate a laser beam that is transmitted along a transmission line in a direction perpendicular to the plumb line, a spectroscope provided in the pendulum along the transmission line of the laser beam to split the laser beam into a split beam and an emitted laser beam that is perpendicular to the split beam, and a cross lens provided along the transmission line of the split beam in the pendulum to transform the split beam into a cross laser beam plane.

### BACKGROUND OF THE INVENTION

1. Field of the Invention

The present invention relates to a laser level, and in particular, to a laser level having a simplified design.

2. Description of the Prior Art

With the rapid development in technology, laser levels have been widely used in construction and decoration works for determining horizontality or verticality. A laser level with an auto-leveling feature can automatically level the device to produce a laser beam plane of proper horizontality or verticality, which in turn projects a horizontal or vertical line for reference on a target. As a result, the auto-leveling laser level has been popular in construction and decoration applications.

There are a number of conventional auto-leveling laser levels that use a pendulum. Unfortunately, in these laser levels, each laser beam plane has to be generated by an individual laser source. As a result, the price and size of the laser level are increased. For example, U.S. Pat. Nos. 5,539,990 and 6,931,739, and Republic of China (Taiwan) Patent No. M247820, all disclose laser levels using an individual laser source for each laser beam plane.

### SUMMARY OF THE INVENTION

It is an object of the present invention to provide a laser level having a simplified design.

It is another object of the present invention to provide a laser level that generates an emitted laser beam and a cross laser beam plane by using a single laser module.

In order to accomplish the above-described and other objects of the present invention, the present invention provides a laser level that generates an emitted laser beam and a cross laser beam plane. The laser level includes a frame, a pendulum pivotally mounted to the frame to rotate about two axes with respect to the frame in a manner such that the gravity center of the pendulum defines a plumb line along the gravity direction, a laser module provided in the pendulum to generate a laser beam that is transmitted along a transmission line in a direction perpendicular to the plumb line, a spectroscope provided in the pendulum along the transmission line of the laser beam to split the laser beam into a split beam and an emitted laser beam that is perpendicular to the split beam, and a cross lens provided along the transmission line of the split beam in the pendulum to transform the split beam into a cross laser beam plane.

### BRIEF DESCRIPTION OF THE DRAWINGS

FIG. 1 is a perspective internal view of a laser level according to one embodiment of the present invention.

FIG. 2 is an exploded perspective view of the laser level of FIG. 1 without its housing.

FIG. 3 is a cross-sectional view of the pendulum and other internal components of FIG. 2 as viewed from the front of the page for FIG. 2.

FIG. 4 is a cross-sectional view of the support, the loader holder, the pendulum and other components of FIG. 2 taken as viewed from the right side of the page for FIG. 2.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

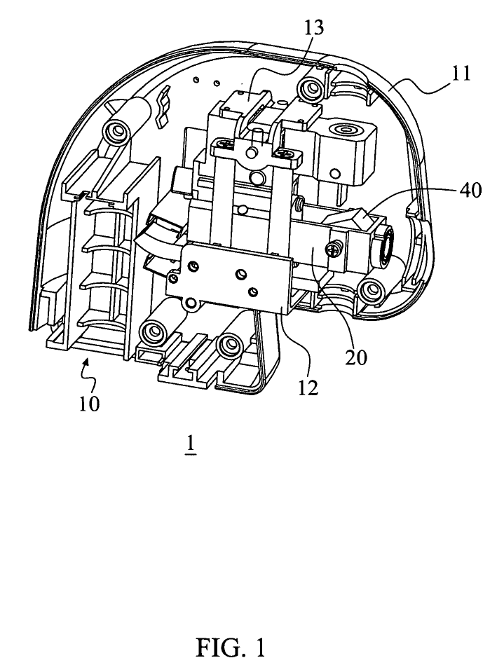

Referring to FIGS. 1-4, a laser level 1 according to one embodiment of the present invention includes a frame 10, a pendulum 20 pivotally mounted to the frame 10 to rotate about at least two axes with respect to the frame 10, a first laser module 30 provided in the pendulum 20, a spectroscope which can be, for example, a pentaprism 40, a wavy cross lens 50, and a second laser module 60. The wavy cross lens 50 can be replaced by any lens which can transform the incident laser beam into a cross laser beam plane.

The frame 10 includes a housing 11, a support 12, and a loader holder 13. The support 12 is secured to the housing 11 by screws (not shown). The loader holder 13 is secured to the support 12 by screws 131 passing through the through holes 132 on the loader holder 13 and into the screw holes 121 of the support 12. The pendulum 20 is pivotally mounted to the loader holder 13 by a bearing seat 70, wherein the pivotal mounting is explained in greater detail below.

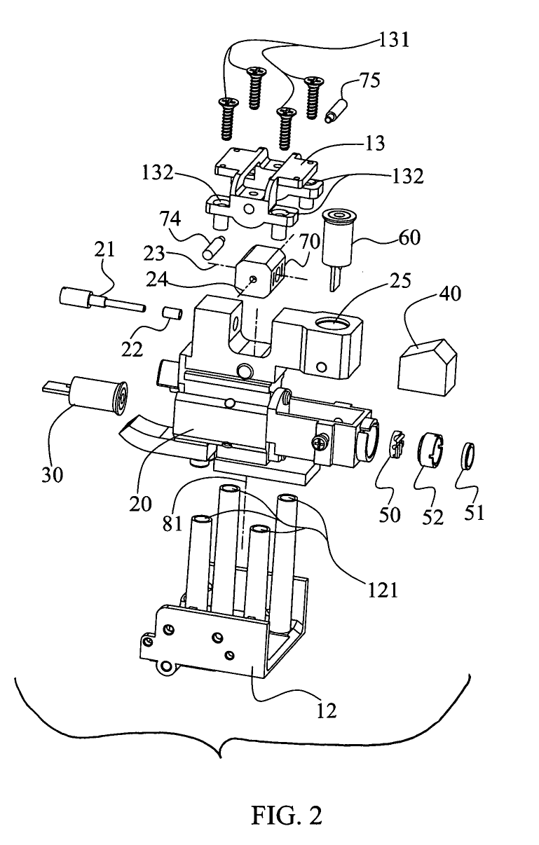

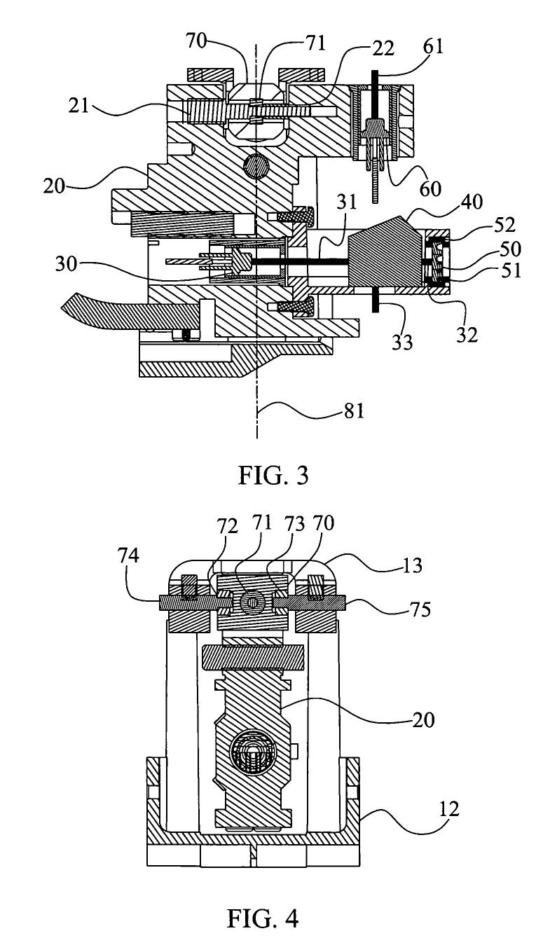

Referring to FIGS. 3 and 4, a concealed bearing 71 is provided in the center of the bearing seat 70. Each end of the bearing 71 is provided with a bearing 72 and 73, respectively, which is concealed inside the bearing seat 70. The rotating axis of the bearings 72 and 73 is perpendicular to the rotating axis of the bearing 71. The center of the bearing 71 is secured to the pendulum 20 by a bearing securing screw 21 and a separating bar 22 that allows the pendulum 20 to rotate or swing about a first axis 23 (see FIG. 2). On the other hand, the centers of the bearings 72 and 73 are secured to the loader holder 13 by shafts 74 and 75 that allow the pendulum 20 to rotate or swing about a second axis 24. The axes 23 and 24 are perpendicular to each other.

The pendulum 20 can swing due to its gravity (as described above), and so the gravity center of the pendulum 20 can define a plumb line 81 in the gravity direction (see FIG. 3). The first laser module 30 is provided in the pendulum 20 to generate a laser beam 31 that is transmitted in a direction perpendicular to the plumb line 81. The pentaprism 40 is provided in the pendulum 20 along the transmission line of the laser beam 31 to split the laser beam 31 into a split beam 32 and a downward emitted laser beam 33 that is perpendicular to the split beam 32. The wavy cross lens 50 is secured onto an adjusting ring 52 by a clamping ring 51 that is provided on the front end of the pendulum 20, such that the split beam 32 can be transformed into a forward projected cross laser beam plane by the wavy cross lens 50.

Because the upper half portion of the wavy cross lens 50 is provided with longitudinal wavy lines, a part of the split beam 32 can be spread into a vertical laser beam plane that is parallel to the plumb line 81 so as to project a vertical reference line on a vertical wall. Furthermore, because the lower half portion of the wavy cross lens 50 is provided with transverse wavy lines, another part of the split beam 32 can be spread into a horizontal laser beam plane that is perpendicular to the plumb line 81 so as to project a horizontal reference line that is perpendicular to the vertical reference line on a vertical wall.

Furthermore, the second laser module 60 is provided in a bore 25 of the pendulum 20 at a location positioned above the pentaprism 40. The position of the laser module 60 is directly above the emitted laser beam 33 that is split by the pentaprism 40 so as to generate another laser beam 61 that is along the same line thereof, but in a direction opposite to, the emitted laser beam 33.

As a result, the laser level 1 according to the present invention provides a simplified design, so that users can aim the light point generated by the emitted laser beam 33 to a reference point on ground, and further use the emitted beam 61 to project another reference point on the ceiling that corresponds to the reference point on ground, thereby providing an effective and accurate reference for alignment for construction applications. In addition, the cross laser beam plane projected forward by the laser level 1 projects an inter-perpendicular cross line on a vertical wall to provide vertical leveling for construction applications. The laser level 1 according to the present invention is solid and dependable, and is able to provide convenience for users.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A laser level that generates an emitted laser beam and a cross laser beam plane, comprising:
a frame;
a pendulum pivotally mounted to the frame to rotate about two axes with respect to the frame in a manner such that the gravity center of the pendulum defines a plumb line along the gravity direction;
a laser module provided in the pendulum to generate a laser beam that is transmitted along a transmission line in a direction perpendicular to the plumb line;
a spectroscope provided in the pendulum along the transmission line of the laser beam to split the laser beam into a split beam and an emitted laser beam that is perpendicular to the split beam; and
a cross lens provided along the transmission line of the split beam in the pendulum to transform the split beam into a cross laser beam plane.

2. The laser level of claim 1, further comprising a second laser module provided in the pendulum to generate a second laser beam that is transmitted along the same line with, in a direction opposite to, the emitted laser beam.

3. The laser level of claim 1, wherein the spectroscope is a pentaprism.

4. The laser level of claim 1, wherein the cross laser beam plane comprises a horizontal laser beam plane and a vertical laser beam plane.

5. The laser level of claim 1, wherein the pendulum is pivotally mounted to the frame by a bearing seat, in which a first bearing is concealingly provided in the center of the bearing seat to allow the pendulum to rotate about a first axis, and each end of the first bearing is concealingly provided with a second bearing and third bearing, respectively, with the rotation axis of the second and third bearings being perpendicular to the rotation axis of the first bearing to allow the pendulum to rotate about a second axis.
